(19) United States
(12) Patent Application Publication
(10) Pub. No.: US 2021/0072879 A1
(43) Pub. Date: Mar. 11, 2021

(54) System and Method for Generating Virtual Reality Tours

(71) Applicant: PIIQ Technologies, Inc., New York, NY (US)

(72) Inventor: Austin Lo, New York, NY (US)

(73) Assignee: PIIQ Technologies, Inc., New York, NY (US)

(21) Appl. No.: 17/018,149

(22) Filed: Sep. 11, 2020

Related U.S. Application Data
(60) Provisional application No. 62/899,010, filed on Sep. 11, 2019.

(51) Int. Cl. G06F 3/0481; G06F 3/01; G06T 15/20; G06T 19/00; G06Q 50/16

(52) U.S. Cl. CPC G06F 3/04815; G06F 3/011; G06T 15/205; G06T 2219/004; G06T 19/006; G06Q 50/163; G06T 2215/16; G06T 19/003

(57) ABSTRACT

Systems and methods for generating virtual reality tours of a property are provided. The system includes a memory and a processor in communication with the memory. The processor receives a first image of a first room and prompts the user to embed a spatial reference point in the first image to identify a transition to a second room. The processor links the first and second rooms, stores a label for the second room in a capture queue, and stores a link from the second to the first image in a linking queue. The processor prompts the user to capture an image of any room stored in the capture queue and complete any link stored in the link queue, and removes same from the respective queue as they are provided. The processor generates the virtual reality tour based on the images and links once the capture and link queues are empty.

### RELATED APPLICATIONS

This application claims priority to U.S. Provisional Patent Application Ser. No. 62/899,010 filed on Sep. 11, 2019, the entire disclosure of which is hereby expressly incorporated by reference.

### BACKGROUND

### Technical Field

The present disclosure relates generally to the field of image processing and virtual reality generation based on real world photographs. More specifically, the present disclosure relates to computer systems and methods for capturing and generating virtual reality tours of buildings using real world photographs and including error detection and correction features.

### Related Art

In the world of real estate, virtual reality tours of property listings are becoming increasingly common as they allow potential buyers to virtually tour a property listing from the comfort of their own home, or from their real estate agent's office. However, the process of generating the virtual reality environment for each listing (e.g., apartment, house, condominium, townhouse, etc.) is difficult and time-consuming, and often requires extensive user involvement. Indeed, the virtual reality environment generation process can require a user to manually connect various photographs of a property listing's rooms, which are then transformed into a virtual reality tour. However, during this process, the user may incorrectly connect/organize the photographs, exclude rooms from the listing, or omit vital landmarks (e.g., doors, thresholds, closets, etc.). These errors can result in the virtual reality tour having inaccuracies, such as dead ends, inaccessible doorways or rooms, or missing rooms, to name a few. These errors and resulting inaccuracies create a less than desirable virtual reality tour and experience, which can dissuade potential buyers.

Accordingly, there is a need for systems and methods for capturing and generating virtual reality tours of buildings using real world photographs that includes error detection and correction features. These and other needs are addressed by the computer systems and methods of the present disclosure.

### SUMMARY

The present disclosure relates to systems and methods for capturing and generating virtual reality tours of buildings using real world photographs, which includes error detection and correction features. Specifically, the system queues captured rooms and hotspot links between rooms as a user captures room images and inserts hotspots. As the user interacts with the system by capturing room images and placing hotspots, the system instructs the user to capture specific images and/or place specific hotspots, and adjusts the queues as such images are captured and hotspots are placed. In doing so, the system improves the accuracy of the generated virtual reality environment, and ensures that nothing is omitted.

### BRIEF DESCRIPTION OF THE DRAWINGS

The foregoing features of the invention will be apparent from the following Detailed Description, taken in connection with the accompanying drawings, in which:

FIGS. 1A and 1B are a flowchart illustrating overall processing steps carried out by the system of the present disclosure;

FIG. 2 is a first portion of a diagram showing a process for capturing images of a property listing and generating a virtual reality tour therefrom;

FIG. 3 is a second portion of a diagram showing the process for capturing images of the property listing and generating the virtual reality tour therefrom;

FIG. 4 is a third portion of a diagram showing the process for capturing images of the property listing and generating the virtual reality tour therefrom;

FIG. 5 is a fourth portion of a diagram showing the process for capturing images of the property listing and generating the virtual reality tour therefrom;

FIG. 6 is a floor plan of the property listing captured in FIGS. 2-4; and

FIG. 7 is a diagram illustrating hardware and software components capable of being utilized to implement an embodiment of the system of the present disclosure.

### DETAILED DESCRIPTION

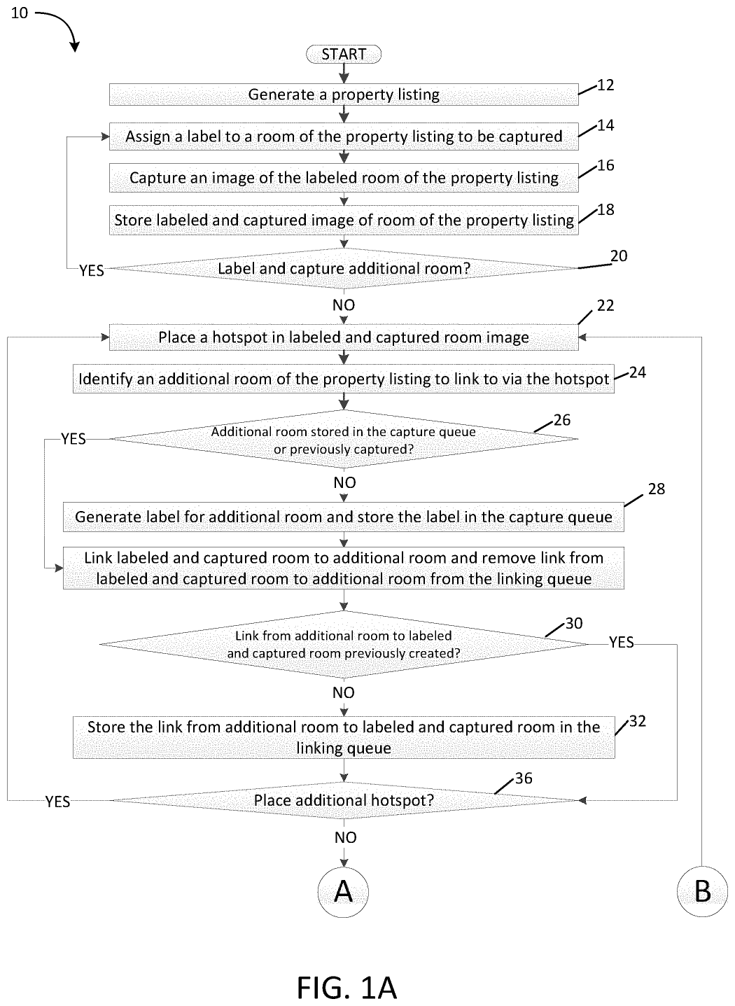

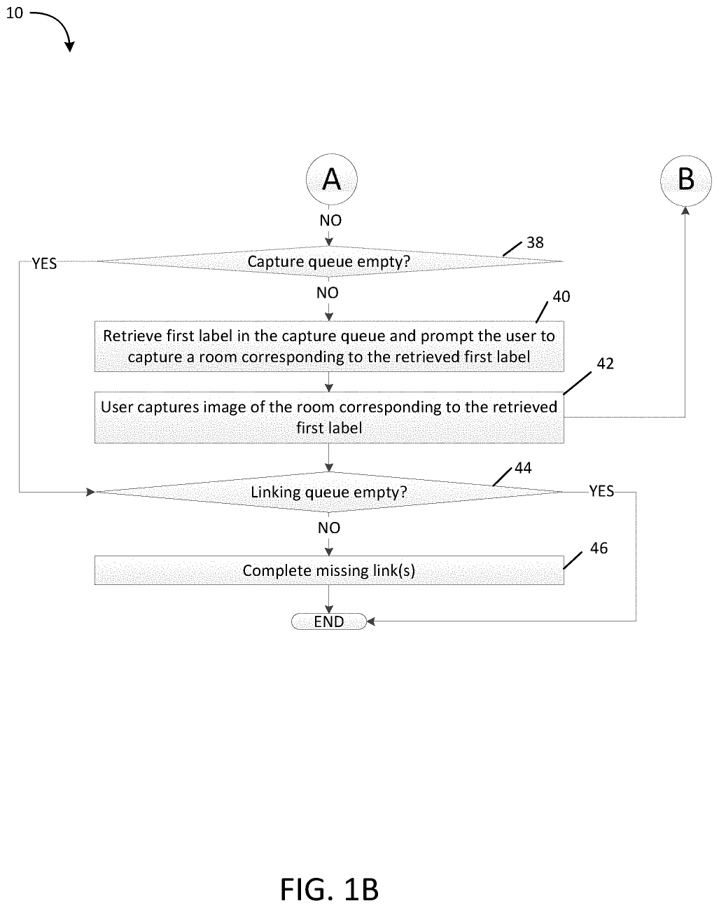

The present disclosure relates to computer systems and methods for capturing and generating virtual reality tours of buildings using real world photographs and including error detection, as described in detail below in connection with FIGS. 1A-7.

As will be discussed in greater detail below, an exemplary high-level user diary for scanning a single property listing is provided, including details relating to a capture queue (CQ) and linking queue (LQ) in accordance with the present disclosure. Turning to the drawings, FIGS. 1A and 1B are a flowchart 10 illustrating overall processing steps carried out by the system of the present disclosure. It should be understood that a software application can form part of the system of the present disclosure and that the software application can execute on a user device including, but not limited to, a smartphone, a tablet, and a computer.

Beginning in step 12, a user opens the application and generates a property listing by navigating one or more graphical user interface (GUI) screens generated by the system and displayed on the user device. In step 14, the system prompts a user to assign a label to a room associated with the property listing that is to be captured in an image. Then, in step 16, the system captures an image corresponding to the labeled room associated with the property listing, e.g., through activation of a camera of the user device by a user. In step 18, the system stores the labeled and captured image of the room associated with the property listing. In step 20, the system asks the user if there are any additional rooms to be labelled and captured. If the system determines, based on user input, that an additional room associated with the property listing is to be labeled and captured, then the process returns to step 14. Alternatively, if the system determines, based on user input, that no additional rooms associated with the property listing are to be labeled and captured, then the process proceeds to step 22.

In step 22, the system prompts the user to place a “hotspot” in a first one of the labeled and captured images, e.g., the first image that was captured which is of a first room. As used herein, “hotspot” refers to a spatial reference point (e.g., a spherical coordinate positioning) that a person viewing a tour of the property listing can trigger to proceed to a next image of the tour. Next, in step 24, the system prompts the user to identify an additional room, e.g., a second room, of the property listing to link to the room captured in the image in which the hotspot was placed. In step 26, the system determines whether the additional room is stored in the capture queue or was previously captured, e.g., a picture of the room is saved and labeled. If the system determines that the additional room is stored in the capture queue or was previously captured, then the process proceeds to step 29, wherein the system links the labeled and captured room, e.g., the first room, to the additional room, e.g., the second room, and removes from the linking queue a link from the labeled and captured room to the additional room. That is, a link from the first room to the second room is removed from the linking queue if present.

Alternatively, if the system determines that the additional room is not stored in the capture queue and was not previously captured, then the process proceeds to step 28. In step 28, the system generates a label for the additional room and stores the label in the capture queue. It should be understood that the label denotes a room that has yet to be captured in an image. The process then proceeds to step 29 where the system links the labeled and captured room, e.g., the first room, to the additional room, e.g., the second room, and removes from the linking queue a link from the labeled and captured room to the additional room. That is, a link from the first room to the second room is removed from the linking queue if present.

Next, in step 30, the system determines whether a link from the additional room, e.g., the second room, to the labeled and captured room, e.g., the first room, was previously created. That is, the system looks to see if a link from the second room to the first room was previously created. If the system determines that the link was already created, then it proceeds to step 36. If the system determines that the link was not previously created, then it proceeds to step 32, where the system stores the link from the additional room to the labeled and captured room in the linking queue. Doing so allows the system to keep track of which links have been created already, and to ensure that all rooms are linked in both directions, e.g., going from a first room to a second room and going from the second room to the first room.

In step 36, the system asks the user if there are additional hotspots to be placed in the labeled and captured room image, e.g., the image in which the previous hotspot was placed. If the user answers “yes,” then the process returns to step 22, and the user is permitted to add another hotspot to the room image, thus linking the room with additional rooms and add additional rooms to the capture queue. Alternatively, if the user answers “no,” then the process proceeds to step 38.

In step 38, the system determines whether the capture queue is empty. If the system determines that the capture queue is empty, then the process proceeds to step 44. Alternatively, if the system determines that the capture queue is not empty, then the process proceeds to step 40. In step 40, the system retrieves a first label stored in the capture queue and prompts the user to capture an image of the room corresponding to the pulled first label. For example, the system can prompt the user to capture an image of a labeled room placeholder. Then in step 42, the user captures the image corresponding to the retrieved first label. Once the user captures the image in step 42, the process returns to step 22 to have the user place the necessary hotspots in that newly captured image. This cycle is repeated until the capture queue is empty and the process proceeds to step 44. In step 44, the system determines whether the linking queue is empty. If the system determines that the linking queue is empty, then the process ends. Alternatively, if the system determines that the linking queue is not empty, then the system prompts the user to complete any outstanding links and the process ends. In this regard, the system processes each of the links still in the linking queue until the linking queue is empty.

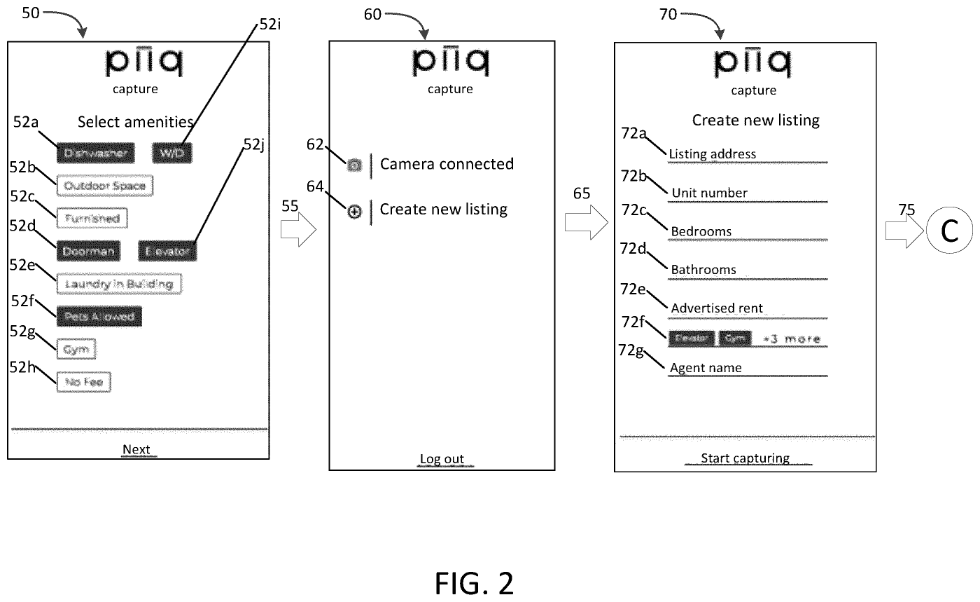

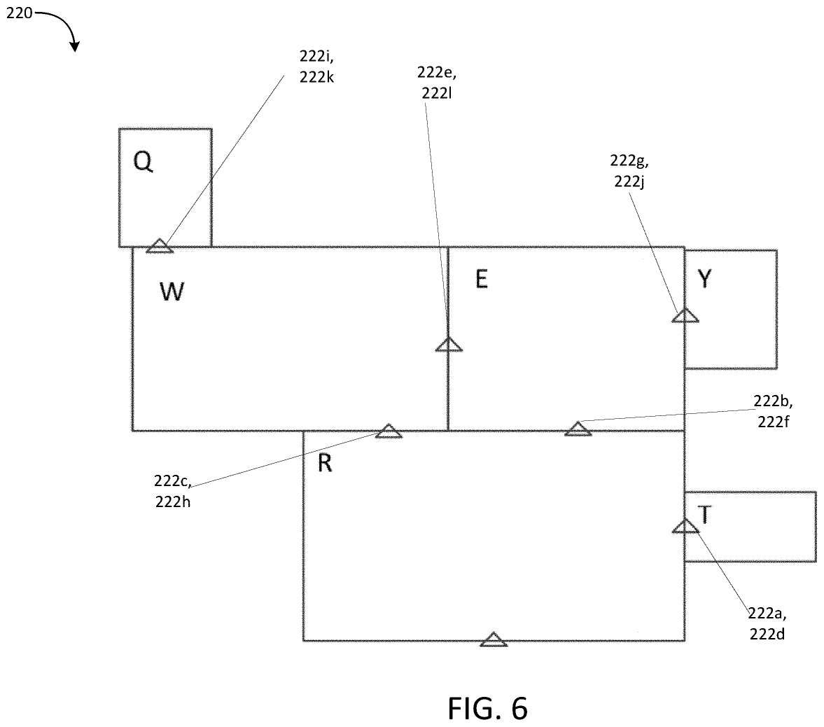

FIGS. 2-5, taken together, illustrate a process for capturing images of the property listing and generating a virtual reality tour therefrom, while FIG. 6 is a floor plan of the property listing.

FIG. 2 is a first portion of a diagram showing a process for capturing images of a property listing and generating a virtual reality tour therefrom, and generally corresponds to step 12 of FIG. 1. In particular, FIG. 2 illustrates graphical user interface (GUI) screenshots 50, 60 and 70 for generating a new property listing via the system software application. First, a user opens the “piiq” application (which is a software application forming part of the system of the present disclosure) on a user device including, but not limited to, a smartphone, a table and a computer and logs in to the application.

Beginning with the GUI screenshot 50, a user can select from a plurality of icons indicative of amenities 52a-j that may be associated with the property listing. For example, the amenities can include but are not limited to, a dishwasher 52a, outdoor space 52b, furnishings 52c, a doorman 52d, onsite laundry 52e, allowance of pets 52f, a gym 52g, a fee waiver 52h, a washer and/or dryer 52i, and an elevator 52j. After selecting the relevant amenities, the process proceeds to the GUI screenshot 60 in step 55.

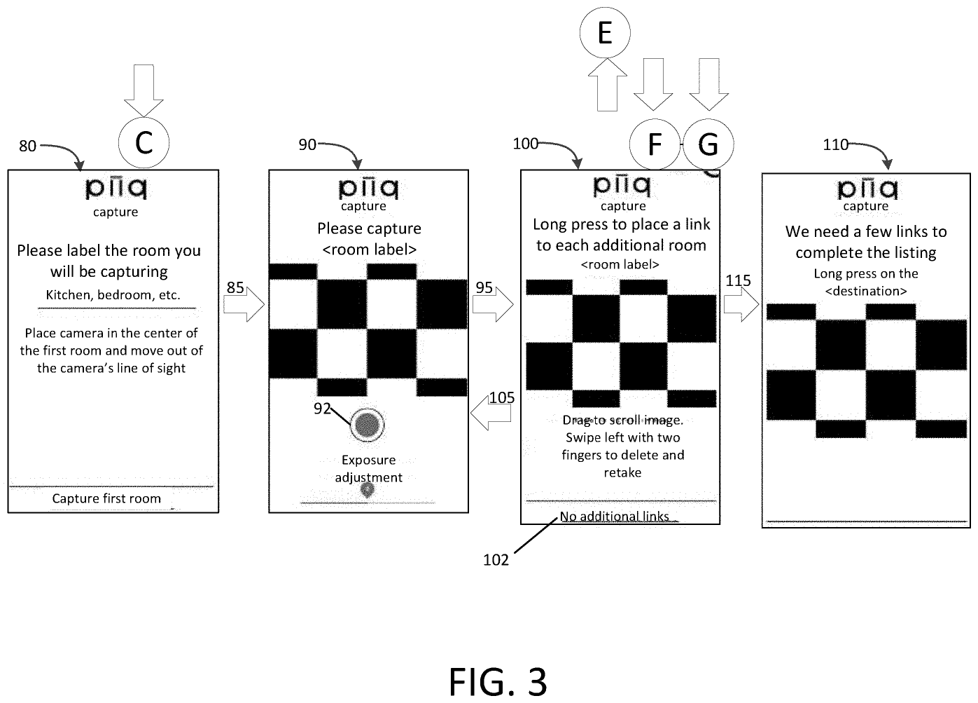

As illustrated by the GUI screenshot 60, the user can connect to a Wi-Fi network associated with a camera and the software executing on the user device can detect the camera and establish a connection therewith. The camera can be a 360 degree and/or virtual reality camera that is capable of capturing 360 degree images and applying spherical coordinates (e.g., hotspots) thereto. A camera icon 62 indicates that the camera is connected to the user device and the user can create the property listing by selecting the icon 64. Then, in step 65, the process proceeds to the GUI screenshot 70. As illustrated by the GUI screenshot 70, the user can edit a plurality of fields indicative of details and/or features 72a-g of and/or associated with the property listing. For example, the details and/or features can include, but are not limited to, an address 72a, a unit number 72b, a number of bedrooms 72c, a number of bathrooms 72d, advertised rent 72e, amenities 72f (corresponding to those amenities selected via the GUI screenshot 50), and an agent 72g. It should be understood that the details and/or features 72a-g can be captured as a JavaScript Object Notation (JSON) object. In step 75 the process proceeds to GUI screenshot 80 (see FIG. 3).

FIG. 3 is a second portion of a diagram showing the process for capturing images of the property listing and generating the virtual reality tour therefrom and generally corresponds to steps 14-22 and 34-44 of FIG. 1. As shown in FIG. 3, Step A is associated with the GUI screenshot 80 in which the user labels a room associated with the property listing and to be captured before capturing an image of the room. Upon labeling the room, the user is prompted to place the camera in the center of the room and move out of the camera's line of sight. In step 85, the process proceeds to the GUI screenshot 90. As illustrated by the GUI screenshot 90, the user is prompted to capture an image of the labeled room. The user can capture the image of the labeled room by selecting the camera icon 92. It should be understood that a user can utilize the camera Wi-Fi connection to adjust one or more settings (e.g., the exposure) of the camera and trigger the camera shutter to capture an image.

In step 95, the process proceeds to the GUI screenshot image 100. Upon capturing an image of the room, the image is downloaded from the camera to a local storage of the user device and the user is prompted to place a hotspot in the captured image to link an additional room associated with the property listing to the captured imaged. In particular, from the GUI screenshot 100, the user selects a location of a hotspot on the captured image and places the hotspot in the selected location by holding the selected location on the captured image displayed on the GUI screenshot 100. As described above, a hotspot corresponds to a spatial reference point (e.g., a spherical coordinate positioning) that a person viewing a tour of the property listing can trigger to proceed to a next image or room of the tour. A hotspot can be placed on an image that has been captured or a placeholder image. Alternatively, the user can swipe left on the captured image displayed on the GUI screenshot 100 to delete the captured image and return to the GUI screenshot 90 to re-capture an image of the room.

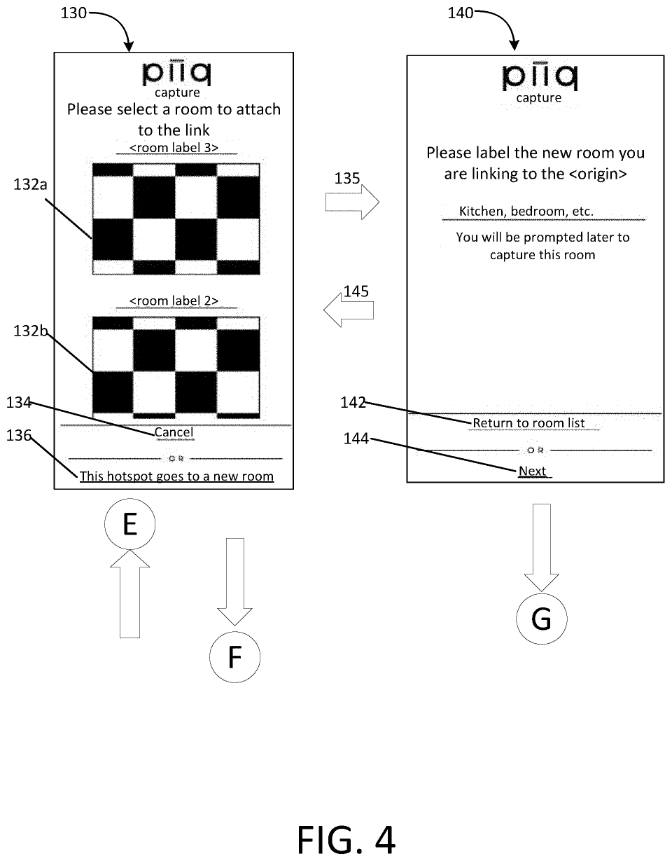

Upon placing the hotspot, the process proceeds to GUI screenshot 130 as shown in FIG. 4. FIG. 4 is a third portion of a diagram showing the process for capturing images of the property listing and generating the virtual reality tour therefrom, and generally corresponds to steps 24-32 of FIG. 1. As shown in GUI screenshot 130, upon selection and placement of the hotspot, the system prompts the user to select a room to link to the captured image having the placed hotspot. The user can select a labelled and captured image stored in the capture queue to link to the captured image having the placed hotspot. For example, the user can select a room image 132a or 132b. Upon selecting a room image 132a, 132b, the system generates and stores a reverse link between the captured image having the placed hotspot and the selected room image in the linking queue.

Alternatively, the user can navigate to GUI screenshot 140 in step 135 by selecting the text button 136 if the user determines that the hotspot should link to a room that has yet to be labeled and captured. As shown in GUI screenshot 140, the system generates a placeholder room and prompts the user to assign a label the placeholder room. It should be understood that a labeled room placeholder denotes an image that has yet to be captured. The system stores the labeled room placeholder in the capture queue, links the image having the placed hotspot and the labeled room placeholder, and stores the reverse link in the linking queue. The user can navigate to GUI screenshot 100 by selecting the text button 144. Alternatively, the user can navigate to GUI screenshot 130 in step 145 by selecting the text button 142 and subsequently navigate to GUI screenshot 100 by selecting the text button 134.

Referring back to FIG. 3 and GUI screenshot 100, the user can select and place another hotspot in the existing room image corresponding to the placed hotspot or a different stored labeled and captured room image. Alternatively, the user can select the text button 102 if no additional hotspots or links are to be added. Upon selecting the text button 102, the system determines whether the capture queue is empty. If the system determines that the capture queue is empty, then the system determines whether the linking queue is empty. If the system determines that the linking queue is not empty then the process proceeds to GUI screenshot 110 in step 115 and prompts the user to complete any outstanding links. In particular, for each link in the linking queue, the system displays the origin image and prompts the user to link the origin image to a destination image by selecting a destination image. It should be understood that the system provides for error checking by storing links in the linking queue and prompting the user to complete any outstanding links.

Alternatively, if the system determines that the capture queue is not empty, then the system prompts the user to capture an image corresponding to a stored label in the capture queue. For example, the system can prompt the user to capture an image corresponding to a labeled room placeholder. It should be understood that the system provides for error checking by storing labels in the capture queue and prompting the user to capture images corresponding to any outstanding labels.

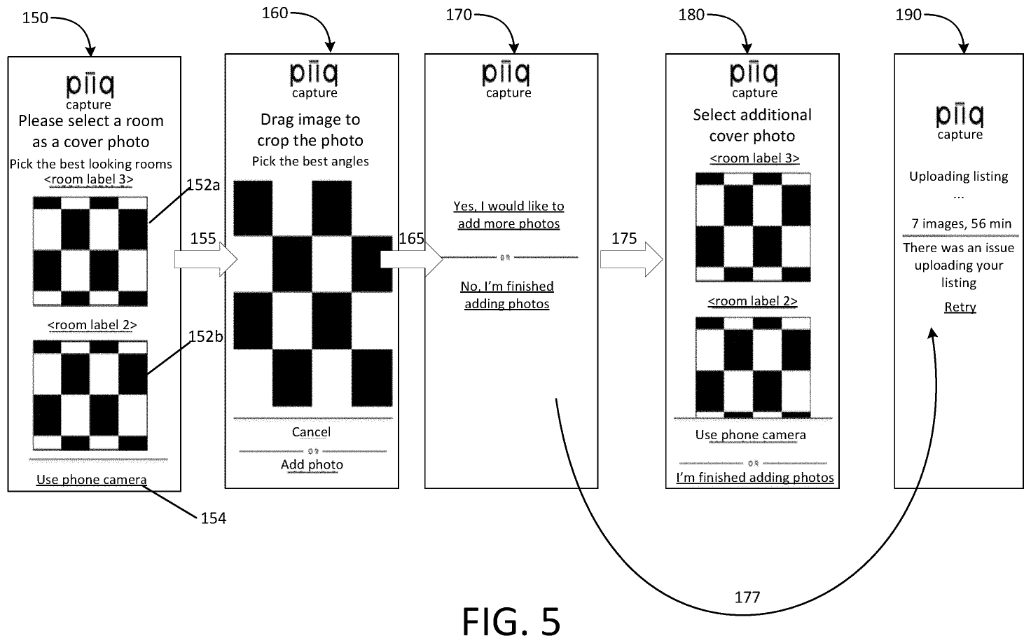

FIG. 5 is a fourth portion of a diagram showing the process for capturing images of the property listing and generating the virtual reality tour therefrom. As shown in GUI screenshot 150, the system provides for selecting a captured room image (e.g., room images 152a or 152b) as a cover photo for the property listing. Alternatively, the user can capture another image and select the captured image as the cover photo by selecting the text button 154. In step 155, the user can navigate to GUI screenshot 160 and edit the selected cover photo image by cropping the image or manipulating it (e.g., rotating the image to pick the best angles or applying a filter to the image). In step 165, the user can navigate to GUI screenshot 170 and select whether they would like to add more photos, or if they are finished adding photos. In step 175, the user can navigate to the GUI screenshot 180 to select an additional cover photo for the property listing if the user desires to add more photos. Alternatively, in step 177, the user can navigate from GUI screenshot 170 to GUI screenshot 190 to upload the selected photos for the property listing if the user does not desire to add more photos.

FIG. 6 is a floor plan of the property listing captured in FIGS. 2-4. The user walks into the property to be listed (e.g., an apartment) and enters a first room R. The user then captures an image of room R, which is uploaded into the system.

The user then places a “hotspot” 222a in the image of the first room R (e.g., a 360 degree image) from room R to a second room T (R→T), which is recorded as a spherical coordinate. As mentioned above, the hotspot is generally a marker that indicates a point of interest in a room or a transition from one room to another room, e.g., a doorway or a threshold. The user can rotate the image until a point is identified that the user would like to place the hotspot, e.g., a doorway or threshold. This can be done by rotating the smartphone or computer, panning on the image in a smartphone or computer, or by way of a virtual reality headset worn by the user that allows the user to turn his or her head and view different portions of the image. Upon placement of the hotspot 222a, the capture queue actions are as follows: room T is added to the capture queue. Upon placement of the hotspot 222a, the linking queue actions are as follows: link T→R is added to the linking queue. The capture queue now includes: [T]; and the linking queue now includes: [T→R].

Next, the user places a hotspot 222b in the image from room R to a third room E (R→E). As such, the capture queue action includes adding room E to the capture queue and the linking queue action includes adding link E→R to the linking queue. Accordingly, the capture queue now includes: [T, E] and the linking queue now includes: [E→R, T→R].

Next, the user places a hotspot 222c from room R to a fourth room W (R→W). As such, the capture queue action includes adding room W to the capture queue and the linking queue action includes adding link W→R to the linking queue. Accordingly, the capture queue now includes: [T, E, W] and the linking queue now includes: [W→R, E→R, T→R].

Next, the user indicates that there are no more hotspots to place, so the system pulls the first element in the capture queue which is room T. The user is then prompted to capture an image of room T. The user then captures an image of room T. As such, room T is subtracted from the capture queue such that the capture queue now includes [E, W].

Next, the user places a hotspot 222d from room T to room R (T→R). As such, the link T→R is removed from the linking queue such that the linking queue now includes [W→R, E→R].

Next, the user indicates there are no more hotspots to place, so the system pulls the first element in the capture queue which is room E. The user is then prompted to capture an image of room E. The user then captures an image of room E. As such the room E is subtracted from the capture queue such that the capture queue now includes [W].

Next, a user places a hotspot 222e from room E to room W (E→W). In this case, a capture queue action is not realized since room W is already present in the capture queue. However, the linking queue action includes adding link W→E to the linking queue. As such, the capture queue now includes: [W] and the linking queue now includes [W→E, W→R, E→R].

Next, the user places a hotspot 222f from room E to room R (E→R). In this case, a capture queue action is not realized since room R is already present in the capture queue. However, the linking queue action includes subtracting link E→R from the linking queue. As such, the capture queue now includes [W] and the linking queue now includes [W→E, W→R].

Next, the user places a hotspot 222g from room E to room Y (E→Y). The capture queue action includes adding room Y to the capture queue and the linking queue action includes adding link Y→E to the linking queue. As such, the capture queue now includes [W,Y] and the linking queue now includes [Y→E, W→E, W→R].

Next, the user indicates there are no more hotspots to place, so the system pulls the first element in the capture queue which is room W. The user is then prompted to capture room W. The user then captures room W. As such, the capture queue action includes subtracting room W from the capture queue such that the capture queue now includes: [Y].

Next, the user places a hotspot 222h from room W to room R (W→R). In this case a capture queue action is not realized because room R was already captured. However, the linking queue action includes removing link W→R from the LQ. As such, the capture queue now includes [Y] and the linking queue now includes [Y→E, W→E].

Next, the user places a hotspot 222i from room W to room Q (W→Q). The capture queue action includes adding room Q to the capture queue and the linking queue action includes adding link Q→W to the linking queue. The capture queue now includes [Y, Q] and the linking queue now includes [Q→W, Y→E, W→E].

If the user forgets to place a hotspot from room W to room E (W→E) and clicks the “no more hotspots” text button, then the system will pull the first element in the capture queue, which is Y, and will instruct the user to capture an image of room Y. The user then captures an image of room Y. The capture queue action includes removing room Y from the capture queue such that the capture queue now includes [Q].

Next, the user places a hotspot 222j from room Y to room E (Y→E). In this case a capture action is not realized because room E was previously captured. However, the linking queue action includes removing the link Y→E from the linking queue. As such, the capture queue now includes [Q] and the linking queue now includes [Q→W ,W→E].

Next, if the user indicates there are no more hotspots to place, the system will pull the first element in the capture queue which is room Q. The user is then prompted to capture an image of room Q. The user then captures an image of room Q. As such the capture queue action includes removing room Q from the capture queue such that the capture queue no longer includes any room labels.

Next, the user places a hotspot 222k from room Q to room W (Q→W). In this case, a capture action is not realized because room W was previously captured. However, the linking queue action includes removing link Q→W from the linking queue. As such, the capture queue no longer includes any room labels and the linking queue now includes [W→E].

Next, the user indicates that s/he is done placing hotspots. The system looks to the capture queue and does not find anything (e.g., the capture queue is empty), so it then checks the linking queue to determine if it is also empty. However, the system identifies that link W→E is present in the linking queue, e.g., the link for W→E still needs to be provided, and loads image W into the capture/linking screen for the user and prompts the user to place a hotspot 2221 to room E (W→E). The user places the hotspot 2221 to room E (W→E). The system checks the linking queue once again and does not find anything (e.g., the linking queue is empty), confirming that no additional rooms or hotspots need to be provided.

Once it is confirmed that there no additional rooms or hotspots need to be provided, the user is directed to upload the completed listing. The system then generates a virtual reality tour of the property listing from the captured images and the hotspots (links) 222a-1 created during the foregoing process. The virtual reality listing can be viewed on a computer screen, or through a virtual reality headset. Accordingly, the system allows for a user to generate a virtual reality environment of a property with integrated error checking and correction at the point of capture.

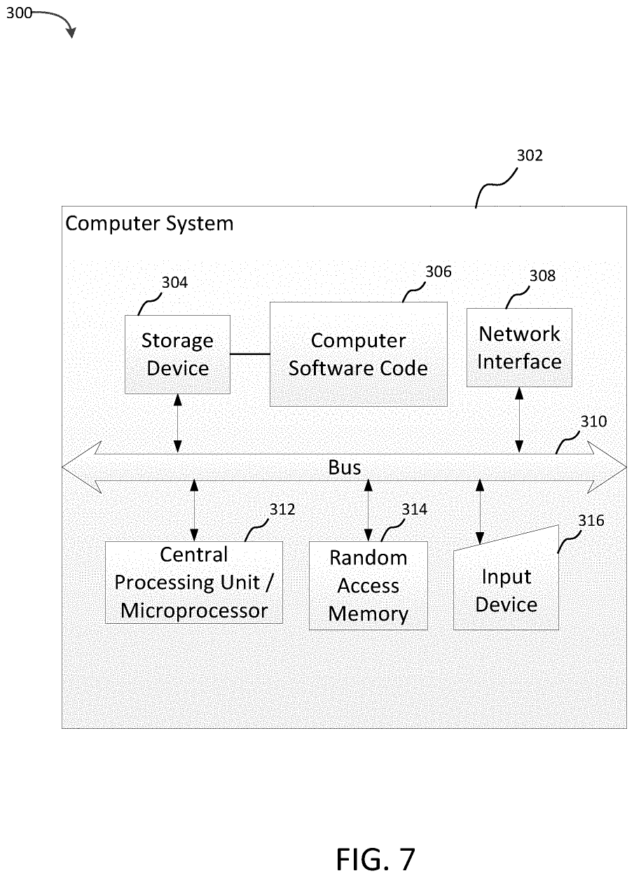

FIG. 7 is a diagram 300 showing hardware and software components of a computer system 302 on which an embodiment of the system of the present disclosure can be implemented. The computer system 302 can include a storage device 304, computer software code 306, a network interface 308, a communications bus 310, a central processing unit (CPU) (microprocessor) 312, a random access memory (RAM) 414, and one or more input devices 316, such as a keyboard, mouse, etc. The CPU 312 could be one or more graphics processing units (GPUs), if desired. The server 302 could also include a display (e.g., liquid crystal display (LCD), cathode ray tube (CRT), etc.). The storage device 304 could comprise any suitable, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.). The computer system 402 could be a networked computer system, a personal computer, a server, a smart phone, tablet computer etc. It is noted that the computer system 302 need not be a networked server, and indeed, could be a stand-alone computer system.

The functionality provided by the present disclosure could be provided by computer software code 306, which could be embodied as computer-readable program code stored on the storage device 304 and executed by the CPU 412 using any suitable, high or low level computing language, such as Python, Java, C, C++, C#, .NET, MATLAB, etc. The network interface 308 could include an Ethernet network interface device, a wireless network interface device, or any other suitable device which permits the server 302 to communicate via the network. The CPU 312 could include any suitable single-core or multiple-core microprocessor of any suitable architecture that is capable of implementing and running the computer software code 306 (e.g., Intel processor). The random access memory 414 could include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A system for generating a virtual reality tour of a property listing, comprising:
a memory; and
a processor in communication with the memory, the processor:
receiving a first image corresponding to a captured image of a first room associated with the property listing, the first image being labeled by a user on a user device,
prompting the user to embed a first spatial reference point in the first image and to link the embedded first spatial reference point to a second image, the first spatial reference point being indicative of a transition between the first room associated with the first image and a second room associated with the second image,
storing a label for the second image in a capture queue,
generating a first link from the first labeled image to the second image based on a first received user input, the first link linking the first labeled image to the second image,
storing a second link from the second image to the first image in a linking queue, the second link linking the second labeled image to the first image,
determining whether the capture queue includes a stored label,
retrieving the label from the capture queue if determined that the capture queue includes a label,
requesting the user capture the second image of the second room corresponding to the label,
receiving the second image corresponding to a captured image of the second room associated with the property listing, the second image being labeled by the user on the user device,
removing the label for the second image from the capture queue upon receipt of the second image,
determining whether the linking queue includes a stored link,
prompting the user complete the stored link if it is determined that the linking queue includes a stored link,
removing the stored link from the linking queue upon completion by the user, and
generating the virtual reality tour of the property listing based on the first image, the second image, the first link, and the second link when (i) the capture queue does not include a label, and (ii) the linking queue does not include a stored link.

2. The system of claim 1, wherein the processor prompts the user to embed a second spatial reference point in the second image and to link the embedded second spatial reference point to the first image, the second spatial reference point being indicative of the transition between the second room associated with the second image and the first room associated with the first image, and removes the second link from the linking queue upon the user embedding the second spatial reference point in the second image.

3. The system of claim 1, wherein the processor prompts the user to embed a second spatial reference point in the first image and to link the embedded second spatial reference point to a third image, the second spatial reference point being indicative of a transition between the first room associated with the first image and a third room associated with the third image.

4. The system of claim 3, wherein the processor
stores a label for the third image in the capture queue,
retrieves the label for the third image stored in the capture queue,
requests the user capture the third image of the third room corresponding to the label for the third image,
receives the third image corresponding to a captured image of the third room associated with the property listing, the third image being labeled by the user on the user device, and
removes the label for the third image from the capture queue upon receipt of the third image.

5. The system of claim 3, wherein the processor
generates a third link from the first labeled image to the third image based on a second received user input, the third link linking the first labeled image to the third image, and
stores a fourth link from the third image to the first image in the linking queue, the fourth link linking the third labeled image to the first image.

6. The system of claim 5, wherein the processor
prompts the user to embed a third spatial reference point in the third image and to link the embedded third spatial reference point to the first image, the third spatial reference point being indicative of the transition between the third room associated with the third image and the first room associated with the first image, and removes the fourth link from the linking queue upon the user embedding the third spatial reference point in the third image.

7. The system of claim 1, wherein the processor determines if the label for the second image is already stored in the capture queue or the second image was previously captured, and does not store the label for the second image in the capture queue if it is determined that the label for the second image is already stored in the capture queue or the second image was previously captured.

8. A method for generating a virtual reality tour for a property listing comprising the steps of:
receiving a first image corresponding to a captured image of a first room associated with the property listing, the first image being labeled by a user on a user device;
prompting the user to embed a first spatial reference point in the first image and to link the embedded first spatial reference point to a second image, the first spatial reference point being indicative of a transition between the first room associated with the first image and a second room associated with the second image;
storing a label for the second image in a capture queue;
generating a first link from the first labeled image to the second image based on a first received user input, the first link linking the first labeled image to the second image;
storing a second link from the second image to the first image in a linking queue, the second link linking the second labeled image to the first image;
determining whether the capture queue includes a stored label;
retrieving the label from the capture queue if determined that the capture queue includes a label;
requesting the user capture the second image of the second room corresponding to the label;
receiving the second image corresponding to a captured image of the second room associated with the property listing, the second image being labeled by the user on the user device;
removing the label for the second image from the capture queue upon receipt of the second image;
determining whether the linking queue includes a stored link;
prompting the user complete the stored link if it is determined that the linking queue includes a stored link;
removing the stored link from the linking queue upon completion by the user; and
generating the virtual reality tour of the property listing based on the first image, the second image, the first link, and the second link when (i) the capture queue does not include a label, and (ii) the linking queue does not include a stored link.

9. The method of claim 8, further comprising the steps of:
prompting the user to embed a second spatial reference point in the second image and to link the embedded second spatial reference point to the first image, the second spatial reference point being indicative of the transition between the second room associated with the second image and the first room associated with the first image; and
removing the second link from the linking queue upon the user embedding the second spatial reference point in the second image.

10. The method of claim 8, further comprising the step of prompting the user to embed a second spatial reference point in the first image and to link the embedded second spatial reference point to a third image, the second spatial reference point being indicative of a transition between the first room associated with the first image and a third room associated with the third image.

11. The method of claim 10, further comprising the steps of:
storing a label for the third image in the capture queue;
retrieving the label for the third image stored in the capture queue;
requesting the user capture the third image of the third room corresponding to the label for the third image;
receiving the third image corresponding to a captured image of the third room associated with the property listing, the third image being labeled by the user on the user device; and
removing the label for the third image from the capture queue upon receipt of the third image.

12. The method of claim 10, further comprising the steps of:
generating a third link from the first labeled image to the third image based on a second received user input, the third link linking the first labeled image to the third image; and
storing a fourth link from the third image to the first image in the linking queue, the fourth link linking the third labeled image to the first image.

13. The method of claim 12, further comprising the steps of:
prompting the user to embed a third spatial reference point in the third image and to link the embedded third spatial reference point to the first image, the third spatial reference point being indicative of the transition between the third room associated with the third image and the first room associated with the first image; and
removing the fourth link from the linking queue upon the user embedding the third spatial reference point in the third image.

14. The method of claim 8, further comprising the steps of:
determining if the label for the second image is already stored in the capture queue or the second image was previously captured; and
not storing the label for the second image in the capture queue if it is determined that the label for the second image is already stored in the capture queue or the second image was previously captured.

15. A non-transitory computer readable medium having instructions stored thereon for generating a property listing virtual reality tour which, when executed by a processor, causes the processor to carry out the steps of:
receiving a first image corresponding to a captured image of a first room associated with the property listing, the first image being labeled by a user on a user device;
prompting the user to embed a first spatial reference point in the first image and to link the embedded first spatial reference point to a second image, the first spatial reference point being indicative of a transition between the first room associated with the first image and a second room associated with the second image;
storing a label for the second image in a capture queue;
generating a first link from the first labeled image to the second image based on a first received user input, the first link linking the first labeled image to the second image;
storing a second link from the second image to the first image in a linking queue, the second link linking the second labeled image to the first image;
determining whether the capture queue includes a stored label;
retrieving the label from the capture queue if determined that the capture queue includes a label;
requesting the user capture the second image of the second room corresponding to the label;
receiving the second image corresponding to a captured image of the second room associated with the property listing, the second image being labeled by the user on the user device;
removing the label for the second image from the capture queue upon receipt of the second image;
determining whether the linking queue includes a stored link;
prompting the user complete the stored link if it is determined that the linking queue includes a stored link;
removing the stored link from the linking queue upon completion by the user; and
generating the virtual reality tour of the property listing based on the first image, the second image, the first link, and the second link when (i) the capture queue does not include a label, and (ii) the linking queue does not include a stored link.

16. The non-transitory computer readable medium of claim 15, further comprising the steps of:
prompting the user to embed a second spatial reference point in the second image and to link the embedded second spatial reference point to the first image, the second spatial reference point being indicative of the transition between the second room associated with the second image and the first room associated with the first image; and
removing the second link from the linking queue upon the user embedding the second spatial reference point in the second image.

17. The non-transitory computer readable medium of claim 15, further comprising the step of prompting the user to embed a second spatial reference point in the first image and to link the embedded second spatial reference point to a third image, the second spatial reference point being indicative of a transition between the first room associated with the first image and a third room associated with the third image.

18. The non-transitory computer readable medium of claim 17, further comprising the steps of:
storing a label for the third image in the capture queue;
retrieving the label for the third image stored in the capture queue;
requesting the user capture the third image of the third room corresponding to the label for the third image;
receiving the third image corresponding to a captured image of the third room associated with the property listing, the third image being labeled by the user on the user device; and
removing the label for the third image from the capture queue upon receipt of the third image.

19. The non-transitory computer readable medium of claim 10, further comprising the steps of:
generating a third link from the first labeled image to the third image based on a second received user input, the third link linking the first labeled image to the third image; and
storing a fourth link from the third image to the first image in the linking queue, the fourth link linking the third labeled image to the first image.

20. The non-transitory computer readable medium of claim 19, further comprising the steps of:
prompting the user to embed a third spatial reference point in the third image and to link the embedded third spatial reference point to the first image, the third spatial reference point being indicative of the transition between the third room associated with the third image and the first room associated with the first image; and
removing the fourth link from the linking queue upon the user embedding the third spatial reference point in the third image.

21. The non-transitory computer readable medium of claim 15, further comprising the steps of:
determining if the label for the second image is already stored in the capture queue or the second image was previously captured; and
not storing the label for the second image in the capture queue if it is determined that the label for the second image is already stored in the capture queue or the second image was previously captured.
